(19) United States
(12) Patent Application Publication
(10) Pub. No.: US 2026/0032346 A1
(43) Pub. Date: Jan. 29, 2026

(54) PAN/TILT HEAD DEVICE, CONTROL METHOD FOR PAN/TILT HEAD DEVICE, AND NON-TRANSITORY COMPUTER-READABLE STORAGE MEDIUM

(71) Applicant: CANON KABUSHIKI KAISHA, Tokyo (JP)

(72) Inventor: SATOSHI ASHITANI, Chiba (JP)

(21) Appl. No.: 19/271,080

(22) Filed: Jul. 16, 2025

(30) Foreign Application Priority Data
Jul. 29, 2024 (JP) 2024-122554
Jul. 29, 2024 (JP) 2024-122555

(51) Int. Cl. H04N 23/695; H04N 23/68

(52) U.S. Cl. CPC H04N 23/695; H04N 23/6815

(57) ABSTRACT

A pan/tilt head device changes a shooting direction of an image capturing unit capturing an image of a subject, and comprises a drive source outputting a drive force; a reduction mechanism reducing the drive force of the drive source; an output shaft, connected to the reduction mechanism, to which the drive force reduced is transmitted, the output shaft changing the shooting direction using the drive force; a first detection unit detecting an output shaft position that is the position of the output shaft; and a control unit controlling the drive source, wherein, based on a condition set in advance, the control unit obtains at least one of the output shaft position and a control position that is a position of the drive source, and obtains a backlash amount, based on the control position and the output shaft position obtained.

### BACKGROUND

### Field of the Technology

The present disclosure relates to a pan/tilt head device, a control method for a pan/tilt head device, and a non-transitory computer-readable storage medium.

### Description of the Related Art

A pan/tilt head device which holds an image capturing apparatus used for surveillance, streaming video, or the like is known. This pan/tilt head device includes a pan driving unit that performs rotational driving in the horizontal direction and a tilt driving unit that performs rotational driving in the vertical direction, and is capable of controlling an image capturing range. The positions of the pan driving unit and the tilt driving unit are controlled by a control unit or the like. In addition, in such a pan/tilt head device, a reference position is set, and the positions of the pan driving unit and the tilt driving unit are controlled based on the reference position. For example, when the pan/tilt head device controls the position based on an absolute value encoder, a value of the absolute value encoder is obtained to determine the reference position.

The pan driving unit and the tilt driving unit of the pan/tilt head device may be configured to rotate an output shaft through a reduction mechanism or the like having a plurality of gears from a motor shaft of a motor to obtain the required torque output. The reduction mechanism has gaps between the plurality of gears, i.e., backlash. This backlash corresponds to a deviation amount in the position control (also called a “backlash amount”). This backlash also produces error in the reference position. Techniques for finding the backlash amount have therefore been disclosed.

For example, Japanese Patent Laid-Open No. 9-247504 (“PTL 1” hereinafter) discloses a technique in which a position detector is provided in each of driving units in a television camera, and each driving unit is driven and controlled based on outputs from the position detectors. According to the technique of PTL 1, an operator manipulates a joystick to drive a driving unit to a preset position, manipulates an operation button to detect the position, and calculates the deviation amount described above.

Furthermore, in a configuration in which driving units of a television camera are driven and controlled based on outputs from position detectors provided in the driving units, PTL 1 discloses a method in which a deviation amount between a designated position and an actual position is calculated, and the driving and control are performed having adjusted the deviation amount.

However, with the past technique disclosed in PTL 1 described above, it is necessary for the operator to operate a joystick or the like, which places a heavy burden on the operator for calculating the backlash amount.

Additionally, although PTL 1 describes driving control performed based on the calculated deviation amount, PTL 1 does not mention setting the reference position. The technique of PTL 1 therefore cannot be applied in an apparatus that performs driving control based on the reference position, and cannot reduce error in the reference position caused by backlash.

### SUMMARY

Accordingly, the present disclosure provides a technique that can reduce the burden on an operator in calculating a backlash amount, and a technique that can reduce error in a reference position caused by backlash in a pan/tilt head device.

The present disclosure in its first aspect provides a pan/tilt head device that changes a shooting direction of an image capturing unit that captures an image of a subject, the pan/tilt head device comprising: a drive source that outputs a drive force; a reduction mechanism that reduces the drive force of the drive source; an output shaft, connected to the reduction mechanism, to which the drive force reduced is transmitted, the output shaft changing the shooting direction of the image capturing unit using the drive force; a first detection unit that detects an output shaft position that is a position of the output shaft; and a control unit that controls the drive source, wherein, based on a condition set in advance, the control unit obtains at least one of the output shaft position and a control position that is a position of the drive source, and obtains a backlash amount, based on the control position and the output shaft position obtained.

The present disclosure in its second aspect provides a control method for a pan/tilt head device that changes a shooting direction of an image capturing unit that captures an image of a subject, the pan/tilt head device including: a drive source that outputs a drive force; a reduction mechanism that reduces the drive force of the drive source; an output shaft, connected to the reduction mechanism, to which the drive force reduced is transmitted, the output shaft changing the shooting direction of the image capturing unit using the drive force; a first detection unit that detects an output shaft position that is a position of the output shaft; and a control unit that controls the drive source, the method comprising: based on a condition set in advance, obtaining at least one of the output shaft position and a control position that is a position of the drive source, and obtaining a backlash amount, based on the control position and the output shaft position obtained.

The present disclosure in its third aspect provides a pan/tilt head device that changes a shooting direction of an image capturing unit that captures an image of a subject, the pan/tilt head device comprising: a drive source that outputs a drive force; a reduction mechanism that reduces the drive force of the drive source; an output shaft, connected to the reduction mechanism, to which the drive force reduced is transmitted, the output shaft changing the shooting direction of the image capturing unit using the drive force; a first detection unit that detects an output shaft position that is a position of the output shaft; and a control unit that controls the drive source, wherein the control unit determines, as a reference position for controlling a position of the drive source, the output shaft position obtained after driving the drive source by an elimination movement amount in an elimination direction, the elimination direction being a direction that eliminates backlash produced by the reduction mechanism.

The present disclosure in its fourth aspect provides a control method for a pan/tilt head device that changes a shooting direction of an image capturing unit that captures an image of a subject, the pan/tilt head device including: a drive source that outputs a drive force; a reduction mechanism that reduces the drive force of the drive source; an output shaft, connected to the reduction mechanism, to which the drive force reduced is transmitted, the output shaft changing the shooting direction of the image capturing unit using the drive force; a first detection unit that detects an output shaft position that is a position of the output shaft; and a control unit that controls the drive source, the method comprising: determining, as a reference position for controlling a position of the drive source, the output shaft position obtained after driving the drive source by an elimination movement amount in an elimination direction, the elimination direction being a direction that eliminates backlash produced by the reduction mechanism.

The present disclosure in its fifth aspect provides a non-transitory computer-readable storage medium storing a computer program that, when read and executed by a computer of a pan/tilt head device that changes a shooting direction of an image capturing unit that captures an image of a subject, the pan/tilt head device including: a drive source that outputs a drive force; a reduction mechanism that reduces the drive force of the drive source; an output shaft, connected to the reduction mechanism, to which the drive force reduced is transmitted, the output shaft changing the shooting direction of the image capturing unit using the drive force; and a first detection unit that detects an output shaft position that is a position of the output shaft, causes the computer to function as: a control unit that controls the drive source, wherein, based on a condition set in advance, the control unit obtains at least one of the output shaft position and a control position that is a position of the drive source, and obtains a backlash amount, based on the control position and the output shaft position obtained.

The present disclosure in its sixth aspect provides a non-transitory computer-readable storage medium storing a computer program that, when read and executed by a computer of a pan/tilt head device that changes a shooting direction of an image capturing unit that captures an image of a subject, the pan/tilt head device comprising: a drive source that outputs a drive force; a reduction mechanism that reduces the drive force of the drive source; an output shaft, connected to the reduction mechanism, to which the drive force reduced is transmitted, the output shaft changing the shooting direction of the image capturing unit using the drive force; and a first detection unit that detects an output shaft position that is a position of the output shaft, causes the computer to function as: a control unit that controls the drive source, wherein the control unit determines, as a reference position for controlling a position of the drive source, the output shaft position obtained after driving the drive source by an elimination movement amount in an elimination direction, the elimination direction being a direction that eliminates backlash produced by the reduction mechanism.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a diagram illustrating the overall configuration of a control system of a pan/tilt head device according to embodiments.

FIG. 2A is a plan view of the pan/tilt head device according to embodiments.

FIG. 2B is a side view of the pan/tilt head device according to embodiments.

FIG. 3 is a diagram illustrating a drive transmission system of a driving unit according to embodiments.

FIG. 4 is a diagram illustrating the relationship between a motor control position and an output shaft position of the driving unit according to a first embodiment.

FIG. 5 is a flowchart illustrating backlash calculation processing in a pan/tilt head device according to the first embodiment.

FIG. 6 is a diagram illustrating the relationship between the motor control position and the output shaft position of the driving unit according to a second embodiment.

FIG. 7 is a flowchart illustrating backlash calculation processing in a pan/tilt head device according to the second embodiment.

FIG. 8 is a diagram illustrating another relationship between the motor control position and the output shaft position of the driving unit according to the second embodiment.

FIG. 9 is a flowchart illustrating other backlash calculation processing in the pan/tilt head device according to the second embodiment.

FIG. 10 is a diagram illustrating the relationship between the motor control position and the output shaft position of the driving unit in a pan/tilt head device according to embodiments.

FIG. 11 is a flowchart illustrating reference position determination processing of a pan/tilt head device according to a third embodiment.

FIG. 12 is a flowchart illustrating reference position determination processing of a pan/tilt head device according to a fourth embodiment.

FIG. 13 is a diagram illustrating an example of a movement amount table according to the fourth embodiment.

FIG. 14 is a flowchart illustrating reference position determination processing of a pan/tilt head device according to a fifth embodiment.

FIG. 15 is a flowchart illustrating reference position determination processing of a pan/tilt head device according to a sixth embodiment.

FIG. 16A is a diagram illustrating the relationship between a motor control position and an output shaft position of a driving unit in an example of a pan/tilt head device, in a state where backlash is relatively tight.

FIG. 16B is a diagram illustrating the relationship between a motor control position and an output shaft position of a driving unit in an example of a pan/tilt head device, in a state where backlash is relatively loose.

FIG. 17 is a block diagram illustrating the hardware configuration of a system control unit.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

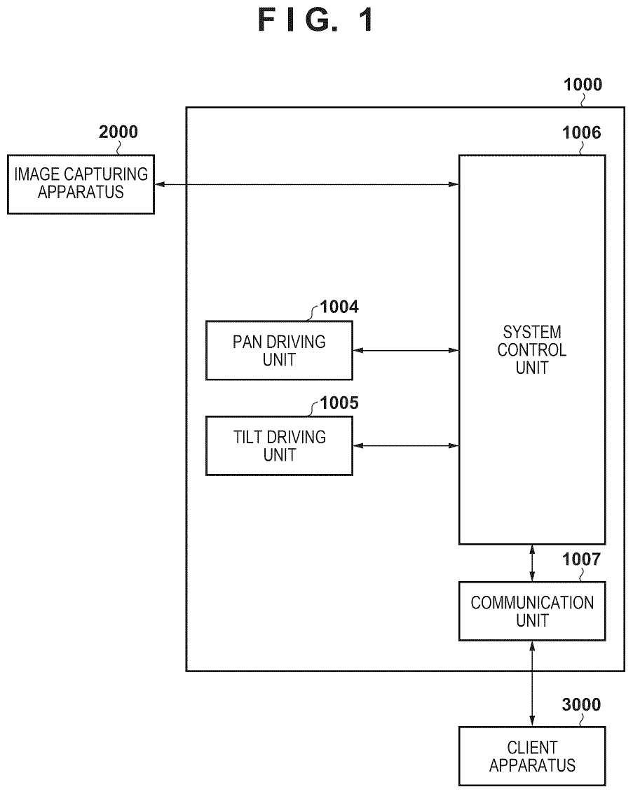

FIG. 1 is a diagram illustrating the overall configuration of a control system of a pan/tilt head device 1000 according to an embodiment. The overall configuration of the pan/tilt head device 1000 will be described with reference to FIG. 1.

The pan/tilt head device 1000 holds an image capturing apparatus 2000 that captures an image of a subject, and changes a shooting direction, including a pan direction and a tilt direction, of the image capturing apparatus 2000. The pan/tilt head device 1000 is connected to the image capturing apparatus 2000 and a client apparatus 3000. The pan/tilt head device 1000 includes a pan driving unit 1004, a tilt driving unit 1005, a system control unit 1006, and a communication unit 1007.

The pan driving unit 1004 performs a pan operation for the pan/tilt head device 1000. The pan operation is an operation that rotates the image capturing apparatus 2000 in the left and right directions (i.e., the horizontal direction), and is an operation of rotating about a vertical axis. The pan driving unit 1004 is connected in a communication-enabling manner to the system control unit 1006 to enable signals such as rotation instructions to be transmitted and received. The pan driving unit 1004 implements pan driving using a mechanism unit that performs the pan operation, such as an actuator, including a brushless DC motor, an encoder that detects a pan position, or the like. In the present embodiment, the pan driving unit 1004 is housed within either a bottom case 1101 or a turntable 1102 (described later).

The tilt driving unit 1005 performs a tilt operation for the pan/tilt head device 1000. The tilt operation is an operation that rotates the image capturing apparatus 2000 in the up and down directions (i.e., the vertical direction), and is an operation of rotating about a horizontal axis that extends to the left and right. The tilt driving unit 1005 is connected in a communication-enabling manner to the system control unit 1006 to enable signals such as rotation instructions to be transmitted and received. The tilt driving unit 1005 implements tilt driving using a mechanism unit that performs the tilt operation, such as an actuator, including a brushless DC motor, an encoder that detects a tilt position, or the like. In the present embodiment, the tilt driving unit 1005 is housed within either a camera head support 1103 or a camera head 1104 (described later).

The system control unit 1006 handles the overall control of the pan/tilt head device 1000. The system control unit 1006 includes a processor such as a central processing unit (CPU). The system control unit 1006 is connected to the client apparatus 3000, which is an information processing device (also referred to as a “computer”), by the communication unit 1007 to enable the transmission and reception of signals. The system control unit 1006 communicates signals including commands and responses with the client apparatus 3000 to control the pan/tilt head device 1000. In other words, the system control unit 1006 receives commands sent from the client apparatus 3000, analyzes the obtained commands, and executes processing in accordance with the commands. The system control unit 1006 then sends a response to the command to the client apparatus 3000. For example, the system control unit 1006 controls the image capturing apparatus 2000 based on instructions in commands related to camera control. The system control unit 1006 controls the pan driving unit 1004 and the tilt driving unit 1005 to rotate the shooting direction of the image capturing apparatus 2000 in the pan direction and the tilt direction based on the instructions in the commands related to pan/tilt control. The system control unit 1006 receives image data, which is data of an image generated by the image capturing apparatus 2000 by capturing an image of a subject. The system control unit 1006 sends the received image data to the client apparatus 3000 through the communication unit 1007. The term “image” may include a still image, a moving image, video, and the data thereof. The system control unit 1006 includes a non-volatile memory, and stores and registers various types of data such as preset positions (described later).

The communication unit 1007 is connected to the client apparatus 3000 over a network, through serial communication, or the like, to enables signals to be sent and received. The communication unit 1007 receives commands related to pan/tilt control and camera control from the client apparatus 3000. The communication unit 1007 sends responses from the system control unit 1006 to the client apparatus 3000. The communication unit 1007 sends image data received from the image capturing apparatus 2000 to the client apparatus 3000.

The image capturing apparatus 2000 includes a lens, an image sensor, and a control circuit unit. The image capturing apparatus 2000 receives light from a subject formed by an optical imaging system that includes a lens, and converts an optical image of the subject into an electrical signal through photoelectric conversion. The image capturing apparatus 2000 generates image data by performing image processing such as development processing, compression, and encoding processing on the photoelectrically-converted electrical signal. The image capturing apparatus 2000 includes an optical zoom control mechanism, and the image capturing angle can be changed. The image capturing apparatus 2000 also includes a focus control mechanism, and the focus of the captured image can be adjusted. The image capturing apparatus 2000 is connected to the pan/tilt head device 1000. Based on instructions from the client apparatus 3000, which are obtained from the pan/tilt head device 1000, the image capturing apparatus 2000 adjusts the shooting angle by controlling the zoom, adjusts the focus of the shot image by adjusting the focus, and the like. The image capturing apparatus 2000 transmits the generated image data to the pan/tilt head device 1000. As a result, the image data is sent to the client apparatus 3000 through the pan/tilt head device 1000.

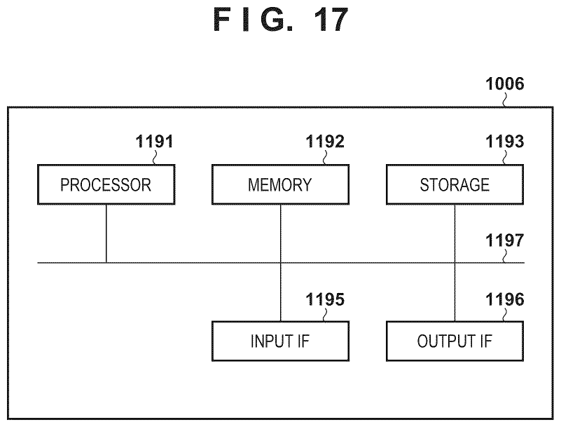

FIG. 17 is a block diagram illustrating the hardware configuration of the system control unit 1006. The system control unit 1006 is, for example, a computer. The system control unit 1006 includes a processor 1191, a memory 1192, storage 1193, an input IF 1195, an output IF 1196, and a bus 1197. The processor 1191, the memory 1192, the storage 1193, the input IF 1195, and the output IF 1196 are connected to each other by the bus 1197 so as to be capable of exchanging information with each other.

The processor 1191 is an arithmetic processing unit, and is, for example, a central processing unit (CPU). Note that the system control unit 1006 may include, instead of or in addition to the CPU, another processor such as a micro processing unit (MPU), a graphics processing unit (GPU), or a quantum processing unit (QPU). The processor 1191 implements various functions and executes various processing by reading out programs stored in the storage 1193 and loading those programs into the memory 1192. For example, the processor 1191 executes each step of backlash calculation processing (described later) by loading a computer program. Note that some or all of the steps in the backlash calculation processing may be executed by one or more circuits, such as an Application Specific Integrated Circuit (ASIC) or a Field Programmable Gate Array (FPGA).

The memory 1192 is, for example, a high-speed readable/writable storage device such as a Random Access Memory (RAM). The memory 1192 functions as a work area when the processor 1191 executes programs. The memory 1192 temporarily stores programs, parameters necessary for executing the programs, and the like. For example, in the backlash calculation processing, the memory 1192 stores a detected motor control position, an output shaft position, a backlash amount that is a result of the processing, and the like.

The storage 1193 is, for example, a non-volatile storage device such as a Hard Disk Drive (HDD) or a Solid State Drive (SSD). The storage 1193 holds programs, parameters necessary for executing the programs, results of executing the programs, and the like even when power is not being supplied thereto.

The input IF 1195 is an interface for accepting input of information from an input device. The input device is a mouse, a keyboard, a touch panel, or the like, for example.

The output IF 1196 is an interface for outputting information such as processing results to a display device such as a display.

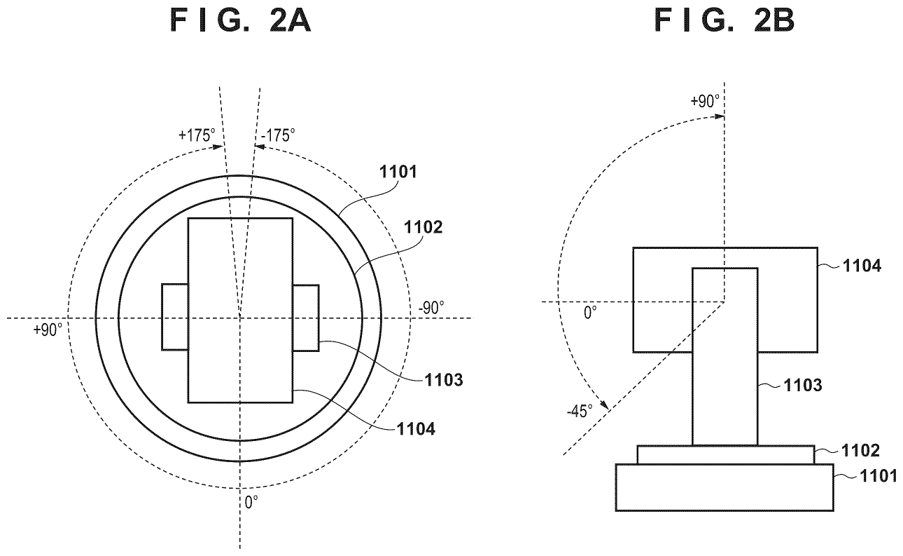

The mechanical configuration of the pan/tilt head device 1000 will be described in detail next with reference to FIGS. 2A and 2B. FIGS. 2A and 2B are a plan view and a side view, respectively, of the pan/tilt head device 1000 according to embodiments. FIG. 2A is a plan view of the mechanical mechanism of the pan/tilt head device 1000 from above the vertical axis. FIG. 2B is a side view of the pan/tilt head device 1000. As illustrated in FIGS. 2A and 2B, the pan/tilt head device 1000 includes the bottom case 1101, the turntable 1102, the camera head support 1103, and the camera head 1104. The present embodiment assumes that the image capturing apparatus 2000 is built into the camera head 1104. In the present embodiment, the pan driving unit 1004 is housed within either the bottom case 1101 or the turntable 1102 (described later).

The bottom case 1101 functions as the entire base portion of the pan/tilt head device 1000, including the pan driving unit 1004 and the tilt driving unit 1005. The bottom case 1101 is disposed below the turntable 1102.

The turntable 1102 performs driving in the pan direction, i.e., a pan operation for the pan/tilt head device 1000, by having the camera head support 1103 or the like (described later) placed thereon and rotating about the vertical axis, which serves as a center axis. The turntable 1102 can rotate from −175 degrees to +175 degrees in the pan direction.

In other words, a mechanism unit, an actuator, and an encoder that perform the pan operation of the pan driving unit 1004 are housed within either the bottom case 1101 or the turntable 1102. This enables the pan driving unit 1004 to rotate the image capturing apparatus 2000 from −175 degrees to +175 degrees in the pan direction. In the present embodiment, the pan driving unit 1004 is housed within either the bottom case 1101 or the turntable 1102, but a different configuration may be used instead. For example, the pan driving unit 1004 may not be built into the bottom case 1101 or the turntable 1102, and may be provided in another member instead.

The camera head support 1103 is a support that extends in the vertical direction and supports the camera head 1104 (described later). The camera head support 1103 is arranged on the center axis of the turntable 1102. The camera head support 1103 holds the camera head 1104 on the opposite side as the side on which the turntable 1102 is located (the upper end, here).

The camera head 1104 is formed having a hollow shape. The camera head 1104 holds the image capturing apparatus 2000. The camera head 1104 is disposed at the upper end of the camera head support 1103. The camera head 1104 performs driving in the tilt direction, i.e., the tilt operation for the pan/tilt head device 1000, with an axis orthogonal to the vertical axis serving as the center axis. The camera head 1104 can rotate from −45 degrees downward to +90 degrees upward in the front-diagonal direction, taking the horizontal direction as 0 degrees.

In other words, a mechanism unit, an actuator, and an encoder that perform the tilt operation of the tilt driving unit 1005 are housed within either the camera head support 1103 or the camera head 1104. As a result, the tilt driving unit 1005 can rotate the image capturing apparatus 2000 from −45 degrees downward to +90 degrees upward in the front-diagonal direction.

In the present embodiment, the tilt driving unit 1005 is housed within either the camera head support 1103 or the camera head 1104, but a different configuration may be used instead. For example, the tilt driving unit 1005 may not be built into either the camera head support 1103 or the camera head 1104, and may be provided in another member instead.

In this manner, the pan/tilt head device 1000 according to the present embodiment can enable the image capturing apparatus 2000 to capture images while changing the image capturing direction by rotating the camera head 1104 in the pan direction or the tilt direction. Note that the driving ranges in the pan direction and the tilt direction in the present embodiment are merely examples, and the driving ranges are not limited thereto. For example, the configuration may be such that the driving in the pan direction and the tilt direction is capable of endless rotation.

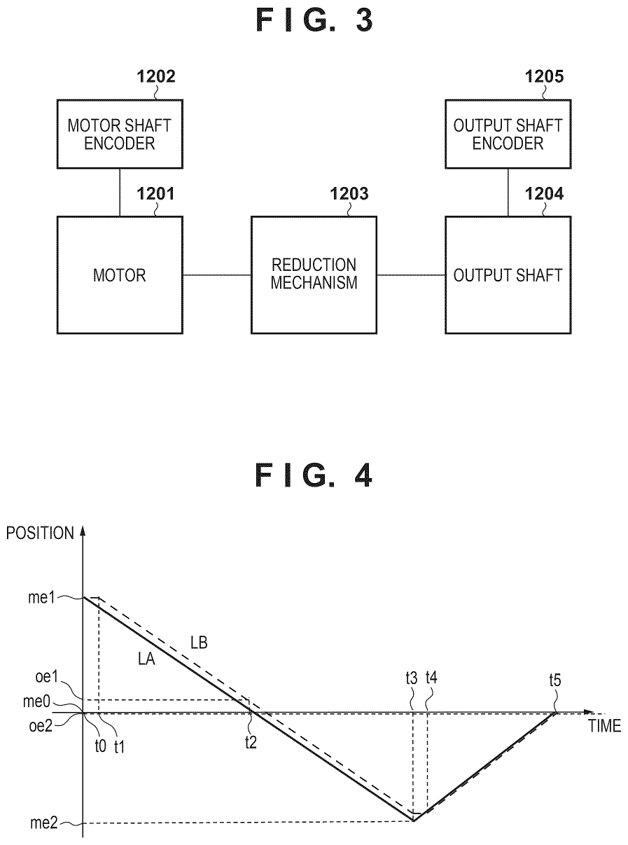

FIG. 3 is a diagram illustrating a drive transmission system of each of the pan driving unit 1004 and the tilt driving unit 1005. The configuration of the drive transmission systems inside the pan driving unit 1004 and the tilt driving unit 1005 will be described with reference to FIG. 3. The pan driving unit 1004 and the tilt driving unit 1005 have substantially the same configuration. Each of the pan driving unit 1004 and the tilt driving unit 1005 includes a motor 1201, a motor shaft encoder 1202, a reduction mechanism 1203, an output shaft 1204, and an output shaft encoder 1205.

The motor 1201 outputs drive force as rotational driving force, and functions as a drive source of the pan driving unit 1004 and the tilt driving unit 1005. The rotation of the motor 1201 rotates the output shaft 1204, which is the rotation shaft for pan or tilt, through the reduction mechanism 1203. As a result, the motor 1201 rotates the image capturing apparatus 2000 in either the pan direction or the tilt direction. The motor 1201 may be a brushless DC motor or the like, for example.

The motor shaft encoder 1202 is provided in a motor shaft. The motor shaft encoder 1202 may be an incremental encoder or the like. The motor shaft encoder 1202 functions as a position detector that detects a position of the motor shaft (also called a “motor control position”). The motor shaft encoder 1202 outputs information on the detected position of the motor shaft to the processor 1191 of the system control unit 1006. The motor shaft encoder 1202 is an example of a drive control position detection unit.

The reduction mechanism 1203 is constituted by a plurality of stages of gears, belts, and the like. The reduction mechanism 1203 reduces the rotational speed of the motor 1201, i.e., reduces the drive force, and outputs the necessary torque to the output shaft 1204.

The output shaft 1204 is connected to the reduction mechanism 1203. Accordingly, the reduced drive force from the motor 1201 is transmitted to the output shaft 1204 through the reduction mechanism 1203, and the output shaft 1204 then outputs the transmitted rotational drive force. As a result, the output shaft 1204 rotates the camera head 1104 in the pan direction or the tilt direction to change the shooting direction of the image capturing apparatus 2000.

The output shaft encoder 1205 is provided in the output shaft 1204. The output shaft encoder 1205 may be an absolute value encoder or the like. The output shaft encoder 1205 functions as a position detector that detects a position of the output shaft (also called an “output shaft position”) of the pan driving unit 1004 and the tilt driving unit 1005. The output shaft encoder 1205 outputs information on the detected position of the output shaft to the processor 1191 of the system control unit 1006. The output shaft encoder 1205 is an example of an output shaft position detection unit.

Although a brushless DC motor is given here as an example of the motor 1201 serving as the drive source, the motor 1201 is not limited thereto, and another type of actuator may be used. Additionally, although a configuration in which an incremental encoder is used as the position detector of the motor shaft and an absolute value encoder is used as the position detector of the output shaft is described here, the configuration is not limited thereto, and another type of position detector may be used. Furthermore, although a configuration in which the position of the output shaft 1204 is detected directly using the output shaft encoder 1205 provided in the output shaft 1204 is described here, the configuration is not limited thereto. The configuration may be one in which an encoder is provided on the rotation shaft rotating from the output shaft 1204 through the reduction mechanism 1203, and the encoder is used to indirectly detect a position on the output shaft 1204.

The processor 1191 of the system control unit 1006 of the pan/tilt head device 1000 according to the present embodiment registers preset information in the storage 1193, the preset information associating the position of the pan driving unit 1004, the position of the tilt driving unit 1005, a zoom control position of the image capturing apparatus 2000, and a preset number with each other. Alternatively, the processor 1191 may register preset information associating the preset number with at least one of the position of the pan driving unit 1004, the position of the tilt driving unit 1005, and the zoom control position. Furthermore, the processor 1191 may register preset information including image quality settings and the like in addition to the position of the pan driving unit 1004, the position of the tilt driving unit 1005, and the zoom control position.

Here, the pan/tilt head device 1000 is configured such that the pan driving unit 1004 and the tilt driving unit 1005 can be controlled from a remote location over a network and a dedicated line. Accordingly, upon accepting, for example, a predetermined command and a registered preset number from an operator at a remote location, the processor 1191 calls the preset information associated with the preset number. The processor 1191 executes a preset function that controls the pan driving unit 1004 and the tilt driving unit 1005 to move to a preset position based on the preset information. Furthermore, the system control unit 1006 implements a function called a “shot”, in which the pan driving unit 1004 and the tilt driving unit 1005 are instructed to move to the preset position within a predetermined time, and the movement time for pan and tilt are controlled together.

FIG. 4 is a diagram illustrating the relationship between the motor control position and the output shaft position of the driving unit according to the first embodiment. In FIG. 4, the horizontal axis is the time axis, and the vertical axis represents the motor control position and the output shaft position. The motor control position indicates the position detected by the motor shaft encoder 1202. The output shaft position indicates the position detected by the output shaft encoder 1205. The solid line indicates a movement trajectory LA of the motor control position detected by the motor shaft encoder 1202. The dotted line indicates a movement trajectory LB of the output shaft position detected by the output shaft encoder 1205.

It is assumed that at time to, the motor 1201 is at a position me1 in the positive direction. The system control unit 1006 drives the motor 1201 in the negative direction from the position me1, to a 0 degree position me0. At this time, the system control unit 1006 controls the motor 1201 based on the motor control position detected by the motor shaft encoder 1202. Here, the motor control position changes linearly, as indicated by the movement trajectory LA. However, even if the motor 1201 rotates, there is a section where the output shaft 1204 does not rotate for a certain period of time from the start of the driving due to backlash in the reduction mechanism 1203. Accordingly, the output shaft position, which is the value of the output shaft encoder 1205, does not change from time t0 to time t1.

Thereafter, as indicated by the movement trajectory LB, the output shaft position detected by the output shaft encoder 1205 begins to change from the point where time t1 is exceeded, and changes linearly thereafter. Then, at time t2, when the motor control position detected by the motor shaft encoder 1202 reaches the 0 degree position, the output shaft position detected by the output shaft encoder 1205 takes on a value of a position oe1 rather than 0 degrees.

Next, the system control unit 1006 drives the motor 1201 in the negative direction from the position me0 to a position me2. It is assumed that at time t3, the motor 1201 was at the position me2 in the negative direction. The system control unit 1006 drives the motor 1201 in the positive direction from the position me2, to the 0 degree position me0. At this time, the system control unit 1006 controls the motor 1201 based on the motor control position detected by the motor shaft encoder 1202. In this control, the motor control position changes linearly, as indicated by the movement trajectory LA. Here, even if the motor rotates, there is a section where the output shaft 1204 does not rotate for a certain period of time from the start of the drive due to the backlash in the reduction mechanism 1203. Accordingly, as indicated by the movement trajectory LB, the value of the output shaft position detected by the output shaft encoder 1205 does not change from time t3 to time t4.

Thereafter, the movement trajectory LB of the output shaft encoder 1205 begins to change from the point where time t4 is exceeded, and changes linearly thereafter. Here, the length of time between time t3 and time t4 is substantially the same as the length of time between time t and time t1. Due to the change in the motor control position between time t3 and time t4, the output shaft position approaches the motor control position, and at time t4, the output shaft position and the motor control position are at the same position. Then, at time t5, when the motor 1201 reaches the 0 degree position, the output shaft position detected by the output shaft encoder 1205 becomes a position oe2 substantially equivalent to 0 degrees, as indicated by the movement trajectory LB. Here, the difference between the values of the position oe1 and the position oe2 is the backlash amount. Accordingly, the system control unit 1006 can calculate the backlash amount by calculating the difference between the output shaft positions obtained when controlling the output shaft to the same position (here, the 0 degree position) in the positive and negative directions, respectively, without requiring the operator to perform operations. Note that the system control unit 1006 may calculate the backlash amount by calculating the difference between the motor control position and the output shaft position at time t2. In other words, the system control unit 1006 may calculate the backlash amount by calculating the difference between the motor control position and the output shaft position at the time when the motor control position becomes 0 degrees. Furthermore, the system control unit 1006 may calculate the backlash amount by calculating the difference between the movement amount of the motor control position and the movement amount of the output shaft position at or after time t1, when the output shaft position begins to change.

It is assumed here that as the backlash amount, the system control unit 1006 calculates the difference between the positions detected by the motor shaft encoder 1202 and the output shaft encoder 1205 when controlling the shafts to the 0 degree position from the positive and negative directions, respectively. However, the calculation is not limited thereto. The system control unit 1006 may calculate the difference between the positions of the motor shaft and the output shaft as the backlash amount when controlling the shafts to the same position from the positive and negative directions, respectively, at a different position.

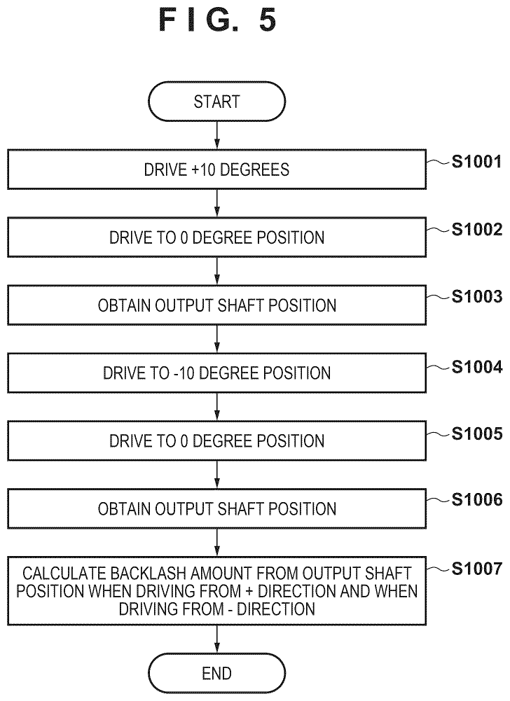

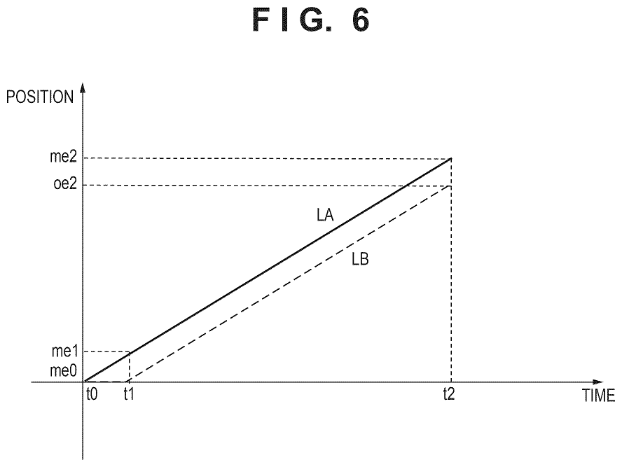

FIG. 5 is a flowchart illustrating the backlash calculation processing in the pan/tilt head device 1000 according to the first embodiment. In this flowchart, the processor 1191 of the system control unit 1006 executes the processing by reading out a computer program from the storage 1193 and loading the program and various types of data into the memory 1192. The system control unit 1006 executes the flowchart in FIG. 5 upon receiving a command instructing the backlash to be calculated. In this flowchart, the system control unit 1006 obtains the output shaft position based on a condition set in advance, and calculates the backlash amount based on the output shaft position. For the sake of simplicity, control processing for the pan direction will be described in the present embodiment, but control processing for the tilt direction is performed through the same flow.

In step S1001, the system control unit 1006 controls the motor 1201 to drive the pan driving unit 1004 in the positive direction, to a position at a predetermined movement amount. Here, the movement amount is a predetermined movement amount sufficient to remove backlash, e.g., 10 degrees. Note that in the descriptions of this flowchart, the movement amount of the pan driving unit 1004 is, for example, the motor control position detected by the motor shaft encoder 1202 of the motor 1201, and refers to the movement trajectory LA.

In step S1002, the system control unit 1006 controls the motor 1201 to drive the pan driving unit 1004 to a 0 degree position. In step S1001, the pan driving unit 1004 is driving from a position at +10 degrees to a position at 0 degrees, and thus the system control unit 1006 drives the pan driving unit 1004 10 degrees in the negative direction. The driving to the 0 degree position in step S1002 is an example of a condition set in advance.

In step S1003, the system control unit 1006 obtains the output shaft position, as the position of the output shaft of the pan driving unit 1004, from the output shaft encoder 1205. For example, the system control unit 1006 obtains +0.01 degrees as the output shaft position.

In step S1004, the system control unit 1006 controls the motor 1201 to drive the pan driving unit 1004 in the negative direction, to a position at a predetermined movement amount. Here too, the movement amount is an amount sufficient to eliminate backlash, e.g., 10 degrees.

In step S1005, the system control unit 1006 controls the motor 1201 to drive the pan driving unit 1004 to a 0 degree position. In step S1004, the pan driving unit 1004 is driving from a position at −10 degrees to a position at 0 degrees, and thus the pan driving unit 1004 is driven 10 degrees in the positive direction. The driving to the 0 degree position in step S1005 is an example of a condition set in advance.

In step S1006, the system control unit 1006 obtains the output shaft position of the pan driving unit 1004 from the output shaft encoder 1205. For example, the system control unit 1006 obtains −0.02 degrees as the output shaft position.

In step S1007, the system control unit 1006 calculates the backlash amount from the obtained output shaft position. Specifically, the system control unit 1006 calculates the backlash amount based on the difference between the output shaft position when driving in the positive direction from the 10 degree position to the 0 degree position and the output shaft position when driving in the negative direction from the 10 degree position to the 0 degree position. For example, taking the values mentioned above, the system control unit 1006 calculates the backlash amount as 0.03 degrees, using the following formula.

$$0.01 - ( - 0.02 ) = 0.03 degrees$$

The system control unit 1006 then ends this processing.

The system control unit 1006 performs the same processing as the pan control described above for the tilt control of the pan/tilt head device 1000 as well.

In this manner, the pan/tilt head device 1000 can obtain the backlash amount present in the pan driving unit 1004 and the tilt driving unit 1005 based on the motor control position and the output shaft position when controlling the pan driving unit 1004 and the tilt driving unit 1005 to the same position from different directions. This makes it possible for the pan/tilt head device 1000 to easily calculate the backlash amount without requiring an operator to make operations. Furthermore, the pan/tilt head device 1000 can reduce stop position error caused by the backlash by using the obtained backlash amount to control the pan driving and the tilt driving.

Here, a configuration has been described in which, in the pan driving unit 1004 and the tilt driving unit 1005, a brushless DC motor is used as the motor 1201 serving as the drive source, a motor shaft encoder 1202 that detects the position of the motor is provided on the motor shaft, and the motor 1201 is controlled using the motor control position detected by the motor shaft encoder 1202 as the control amount of the motor 1201. However, the configuration is not limited to this example. For example, the same method may be used in a configuration in which a stepping motor is used as the motor 1201 serving as the drive source and position control is performed using a pulse number or a step number of the stepping motor as the control amount.

Although the first embodiment describes calculating the backlash amount through driving in both the positive and negative directions, the calculation method is not limited thereto. For example, the system control unit 1006 may calculate the backlash amount based on the motor control position and the output shaft position at a point in time when the motor 1201 is driven in one of these directions to drive the motor control position to a predetermined position (e.g., the 0 degree position). Specifically, the system control unit 1006 may calculate the backlash amount based on the difference between the movement amount of the output shaft position and the movement amount of the motor control position (here, the 0 degree position) at the point in time when the motor 1201 is driven in one of these directions to drive the motor control position to a predetermined position (e.g., the 0 degree position).

### Second Embodiment

A method for calculating the backlash at the start of driving during a reversal operation will mainly be described as a second embodiment, with reference to FIGS. 6 to 9. Elements that are the same as those in the first embodiment will be given the same reference signs as those already used, and detailed descriptions thereof will be omitted, with the descriptions instead focusing on the differences from the first embodiment. Such descriptions may be omitted in the same manner in the other embodiments described later.

FIG. 6 is a diagram illustrating the relationship between the motor control position and the output shaft position of the driving unit according to second embodiment. In FIG. 6, the horizontal axis is the time axis, whereas the vertical axis represents the motor control position, i.e., the value of the motor shaft encoder 1202, and the output shaft position, i.e., the value of the output shaft encoder 1205. The solid line indicates the movement trajectory LA of the motor shaft encoder 1202. The dotted line indicates the movement trajectory LB of the output shaft encoder 1205.

FIG. 6 illustrates behavior during a reversal operation, i.e., when starting to move in the positive direction after driving in the negative direction. It is assumed that at time t0, the motor 1201 is at the 0 degree position me0. The system control unit 1006 drives the motor 1201 in the positive direction from the position me0 to the position me2. At this time, the system control unit 1006 controls the motor 1201 based on the motor control position, which is the value of the motor shaft encoder 1202. Here, the motor shaft encoder 1202 changes linearly, as indicated by the movement trajectory LA. However, even if the motor 1201 rotates, there is a section where the output shaft 1204 does not rotate for a certain period of time from the start of the drive due to the backlash in the reduction mechanism 1203. Accordingly, the output shaft position, which is the value of the output shaft encoder 1205, does not change from time to t0 time t1. Then, as indicated by the movement trajectory LB, the output shaft position detected by the output shaft encoder 1205 begins to change at the point where time t1 is exceeded, i.e., after driving that bring the value of the motor shaft encoder 1202 to the position me1, and changes linearly thereafter. Then, at time t2, when the motor control position detected by the motor shaft encoder 1202 reaches the position me2, the output shaft position detected by the output shaft encoder 1205 is at the position oe2, at which the shaft has traveled a slightly insufficient amount.

Here, the difference between the values of the position me0 and the position me1 detected by the motor shaft encoder 1202 is the backlash amount. In this manner, the backlash amount can be calculated from the motor shaft encoder value according to the change in the output shaft encoder 1205 at the start of driving during the reversal operation.

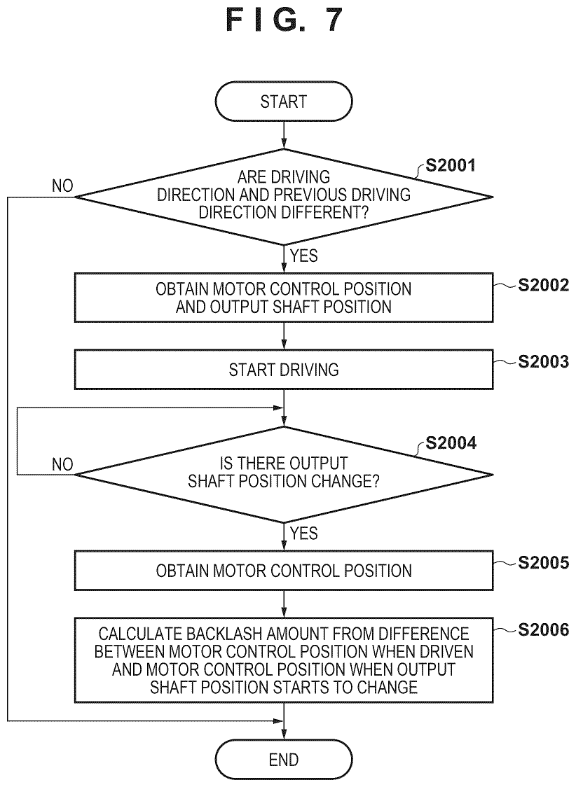

FIG. 7 is a flowchart illustrating the backlash calculation processing in the pan/tilt head device 1000 according to the second embodiment. In this flowchart, the processor 1191 of the system control unit 1006 executes the processing by reading out a computer program from the storage 1193 and loading the program and various types of data into the memory 1192. The system control unit 1006 executes the flowchart in FIG. 7 upon receiving a pan driving command. In this flowchart, the system control unit 1006 obtains the motor control position based on a condition set in advance, and calculates the backlash amount based on the motor control position. For the sake of simplicity, control processing for the pan direction will be described in the present embodiment, but control processing for the tilt direction is performed through the same flow.

In step S2001, the system control unit 1006 determines whether a new driving direction is different from the previous driving direction. If the system control unit 1006 determines that the driving direction is different, i.e., that the driving direction has been reversed, the sequence moves to step S2002. However, if the system control unit 1006 determines that the driving direction is the same, this processing ends.

In step S2002, the system control unit 1006 obtains, from the motor shaft encoder 1202 and the output shaft encoder 1205, the motor control position and the output shaft position in the pan driving at the start of driving after the reversal. Here, the system control unit 1006 obtains, for example, 0.01 degrees for both the motor control position and the output shaft position. The point in time of the start of driving after the reversal is an example of a condition set in advance.

In step S2003, the system control unit 1006 controls the motor 1201 to start driving the pan driving unit 1004.

In step S2004, the system control unit 1006 determines whether the output shaft position has changed. Specifically, the system control unit 1006 obtains the output shaft position of the pan driving unit 1004 from the output shaft encoder 1205. The system control unit 1006 compares the newly-obtained output shaft position with the output shaft position at the start of the driving, and determines whether the output shaft position has changed. If the output shaft position is determined to have changed, the system control unit 1006 moves the sequence to step S2005. However, if the output shaft position is determined not to have changed, the system control unit 1006 returns the sequence to step S2004, and the processing continues until the output shaft position is determined to have changed. The output shaft position having changed is an example of a condition set in advance.

In step S2005, the system control unit 1006 obtains the motor control position from the motor shaft encoder 1202. Here, for example, 0.03 degrees is obtained as the motor control position.

In step S2006, the system control unit 1006 calculates the backlash amount from the difference between the motor control position at the start of the driving and the motor control position at the point in time when the output shaft position detected by the output shaft encoder 1205 starts to change. For example, taking the values mentioned above, the system control unit 1006 calculates the backlash amount as 0.02 degrees, using the following formula.

$$0.03 - 0.01 = 0.02 degrees$$

The system control unit 1006 then ends this processing.

The system control unit 1006 performs the same processing as the pan control described above for the tilt control of the pan/tilt head device 1000 as well.

In this manner, the pan/tilt head device 1000 obtains the backlash amount present in the driving units using the motor control position at the point in time when the motor control position and the output shaft position begin to change during reversal operations of the pan driving unit 1004 and the tilt driving unit 1005. This makes it possible for the pan/tilt head device 1000 to calculate the backlash amount without requiring an operator to make operations. Furthermore, the pan/tilt head device 1000 can reduce stop position error caused by the backlash by performing the control using the obtained backlash amount.

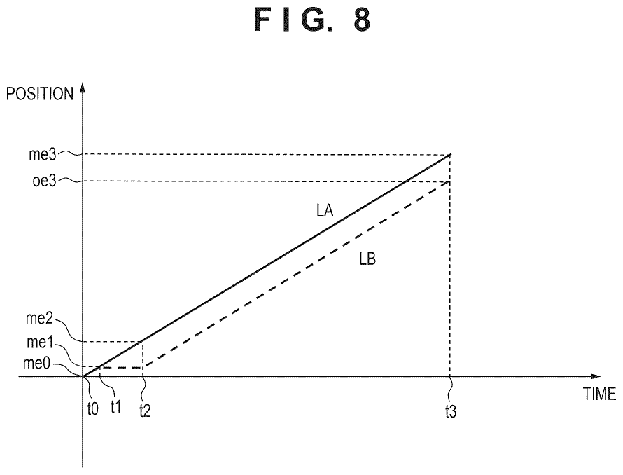

FIG. 8 is a diagram illustrating another relationship between the motor control position and the output shaft position of the driving unit according to the second embodiment. In FIG. 8, the horizontal axis is the time axis, whereas the vertical axis represents the motor control position, i.e., the value of the motor shaft encoder 1202, and the output shaft position, i.e., the value of the output shaft encoder 1205. The solid line indicates the movement trajectory LA of the motor shaft encoder 1202. The dotted line indicates the movement trajectory LB of the output shaft encoder 1205.

FIG. 8 illustrates behavior during a reversal operation, i.e., when starting to move in the positive direction after driving in the negative direction. It is assumed that at time t0, the motor 1201 is at the 0 degree position me0. The system control unit 1006 drives the motor 1201 in the positive direction from the position me0 to the position me2. At this time, the system control unit 1006 controls the motor 1201 based on the motor control position, which is the value of the motor shaft encoder 1202. During this period, the movement trajectory LA of the motor shaft encoder 1202 changes linearly. However, there is a period in which the output shaft position, which is the value of the output shaft encoder 1205, is driven a minute amount from the point in time when the driving starts. Specifically, the output shaft position detected by the output shaft encoder 1205 changes to the position me1 during the period from time t0 to time t1, i.e., the period up to when the motor control position detected by the motor shaft encoder 1202 becomes the position me1. This change indicates a phenomenon observed due to the characteristics of the drive transmission system, and particularly a spring component of the drive transmission system. This is a state in which the backlash is tight at a point in time before driving in the negative direction is complete in the driving of the motor 1201 before the reversal operation, and the drive transmission system is charged with the force from the spring component present in the drive transmission system.

The charged force is then released during the reversal operation, causing the output shaft 1204 to be driven a minute amount as indicated from time to t0 time t1. Even if the motor 1201 rotates due to the backlash in the reduction mechanism 1203 for a certain period of time as described above after being driven a minute amount, a period of time where the output shaft 1204 does not rotate will be present. Specifically, the output shaft position detected by the output shaft encoder 1205 does not change from time t1 to time t2. Then, the output shaft position detected by the output shaft encoder 1205 begins to change when time t2 is exceeded, i.e., after the motor control position detected by the motor shaft encoder 1202 exceeds the position me2. Thereafter, the output shaft position detected by the output shaft encoder 1205 follows the movement trajectory LB, which changes linearly. Then, at time t3, when the motor control position detected by the motor shaft encoder 1202 reaches a position me3, the output shaft position detected by the output shaft encoder 1205 takes on the value of a position oe3, at which the shaft has traveled a slightly insufficient amount.

In the case of a driving mechanism having such characteristics, the backlash amount can be measured based on the difference between the value of the position me1 and the value of the position me2 detected by the motor shaft encoder 1202 at a point in time when the change stops after the minute change following the start of driving has ended and before the change starts again, rather than the point in time when the driving begins.

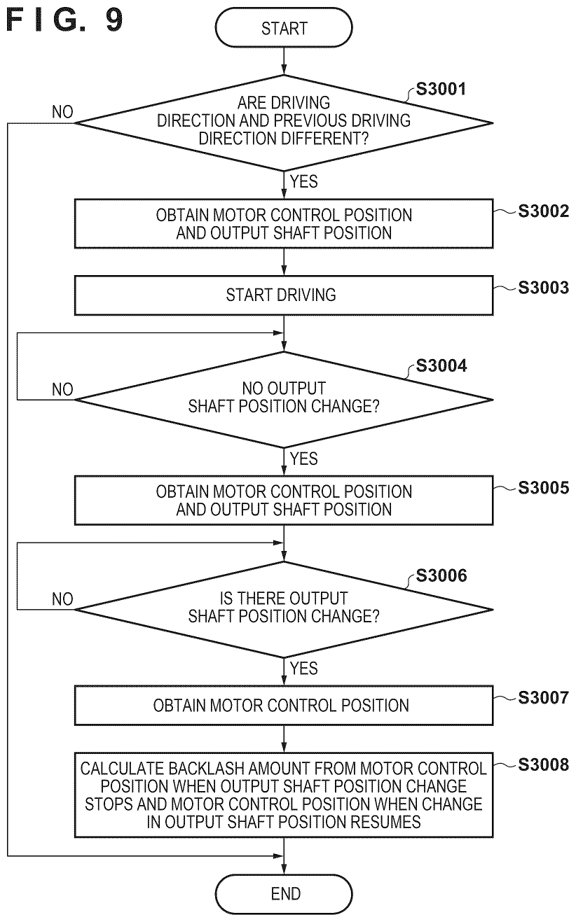

FIG. 9 is a flowchart illustrating other backlash calculation processing in the pan/tilt head device 1000 according to the second embodiment. In this flowchart, the processor 1191 of the system control unit 1006 executes the processing by reading out a computer program from the storage 1193 and loading the program and various types of data into the memory 1192. The system control unit 1006 executes the flowchart in FIG. 9 upon receiving a pan driving command. For the sake of simplicity, control processing for the pan direction will be described in the present embodiment, but control processing for the tilt direction is performed through the same flow.

In step S3001, the system control unit 1006 determines whether a new driving direction is different from the previous driving direction. If the system control unit 1006 determines that the driving direction is different, i.e., that the driving direction has been reversed, the sequence moves to step S3002. However, if the system control unit 1006 determines that the driving direction is the same, this processing ends.

In step S3002, the system control unit 1006 obtains, from the motor shaft encoder 1202 and the output shaft encoder 1205, the motor control position and the output shaft position in the pan driving unit 1004 at the point in time when the driving begins after the reversal.

In step S3003, the system control unit 1006 controls the motor 1201 to start driving the pan driving unit 1004.

In step S3004, the system control unit 1006 determines whether the output shaft position has changed. Specifically, the system control unit 1006 obtains the output shaft position of the pan driving unit 1004 from the output shaft encoder 1205. The system control unit 1006 compares the newly-obtained output shaft position with the previously-obtained output shaft position, and determines whether the position has changed, i.e., whether the change has stopped. If the change is determined to have stopped, and it is determined that there is no change, the system control unit 1006 moves the sequence to step S3005. However, if it is determined that there is change, the system control unit 1006 repeats step S3004 until the change is stopped and it is determined that there is no change. The output shaft position after the reversal not changing is an example of a condition set in advance.

In step S3005, the system control unit 1006 obtains the motor control position and the output shaft position of the pan driving unit 1004 from the motor shaft encoder 1202 and the output shaft encoder 1205. Here, the system control unit 1006 obtains 0.02 degrees, for example, as the motor control position.

In step S3006, the system control unit 1006 determines whether there is change in the output shaft position which is currently stopped. Specifically, the system control unit 1006 obtains the output shaft position of the pan driving unit 1004 from the output shaft encoder 1205. The system control unit 1006 compares the newly-obtained output shaft position with the output shaft position at the point in time when the output shaft position obtained in step S3005 has stopped changing, and determines whether the output shaft position has changed. If it is determined that the output shaft position has changed, i.e., that the change in the output shaft position that had stopped once has resumed, the system control unit 1006 moves the sequence to step S3007. However, if the output shaft is determined not to have changed, the system control unit 1006 returns the sequence to step S3006, and the processing continues until the output shaft position is determined to have changed. The change in the output shaft position resuming having been stopped is an example of a condition set in advance.

In step S3007, the system control unit 1006 obtains the motor control position from the motor shaft encoder 1202. Here, the system control unit 1006 obtains 0.03 degrees, for example, as the motor control position.

In step S3008, the system control unit 1006 calculates the backlash amount based on the difference between the motor control position at the point in time when the change in the output shaft position stops and the motor control position at the point in time when the change in the output shaft position resumes. The point in time when the change in the output shaft position stops is time t1 in FIG. 8. The point in time when the change in the output shaft position resumes is time t2 in FIG. 8. For example, taking the values mentioned above, the system control unit 1006 calculates the backlash amount as 0.01 degrees, using the following formula.

$$0.03 - 0.02 = 0.01 degrees$$

The system control unit 1006 then ends this processing.

The system control unit 1006 performs the same processing as the pan control described above for the tilt control of the pan/tilt head device 1000 as well.

In this manner, the pan/tilt head device 1000 obtains the backlash amount present in the driving unit using the motor control position at the points in time when the output shaft position stops changing and resumes changing again after the start of driving in the reversal operation of the pan driving unit 1004 and the tilt driving unit 1005. This makes it possible for the pan/tilt head device 1000 to calculate the backlash amount without requiring an operator to make operations. Furthermore, the pan/tilt head device 1000 can reduce stop position error caused by the backlash by performing the control using the obtained backlash amount.

Although the present disclosure describes a case where the reversal operation is performed at the 0 degree position, the configuration is not limited thereto, and the measurement may be performed when the reversal operation is performed at a predetermined position that is not 0 degrees. Furthermore, although a case where the reversal operation is performed from the negative direction to the positive direction is described here, the configuration is not limited thereto, and the measurement may be performed when the reversal operation is performed from the positive direction to the negative direction as well.

### Third Embodiment

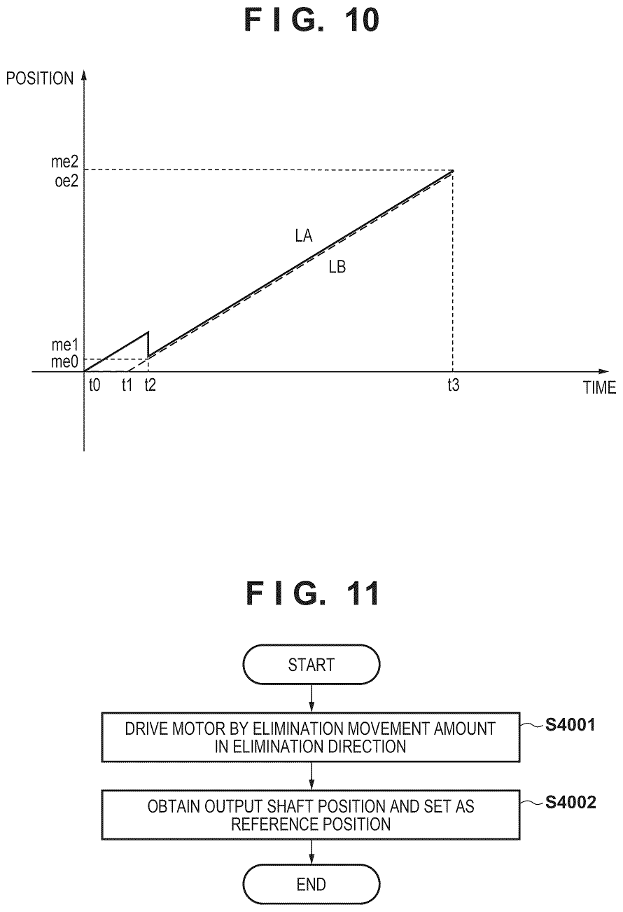

FIG. 10 is a diagram illustrating the relationship between the motor control position and the output shaft position of the driving unit in the pan/tilt head device 1000 according to embodiments. In FIG. 10, the horizontal axis represents time. The vertical axis represents the motor control position, i.e., the value of the motor shaft encoder 1202, and the output shaft position, i.e., the value of the output shaft encoder 1205. The solid line indicates a movement trajectory LA of the motor control position detected by the motor shaft encoder 1202. The dotted line indicates a movement trajectory LB of the output shaft position detected by the output shaft encoder 1205.

At time to in FIG. 10, the backlash is relatively loose. As such, when the system control unit 1006 reads out the output shaft position, which is the value of the output shaft encoder 1205, at the position me0 at time t0, and determines that output shaft position as the reference position, error arises in the reference position as described above. Accordingly, the system control unit 1006 drives the motor 1201 in an elimination direction by a movement amount that is minute but is sufficient to eliminate the backlash (also called an “elimination movement amount” hereinafter). The elimination direction may be a direction in which the backlash is removed or eliminated. The elimination movement amount sufficient to eliminate the backlash may be, for example, a movement amount greater than the maximum backlash. From time to t0 time t1 after the start of driving, the output shaft 1204 does not rotate due to the backlash. Accordingly, the output shaft position detected by the output shaft encoder 1205 does not change during this period, and only begins to change after time t1. The system control unit 1006 reads out the output shaft position detected by the output shaft encoder 1205 at time t2, when the motor 1201 has been driven by a movement amount sufficient for eliminating the backlash, and determines the read-out position me1 as the reference position. The system control unit 1006 may also set the motor control position to the position me1 as the reference position.

After this, the system control unit 1006 controls the position of the motor 1201 based on the motor control position using the determined reference position, to cause the motor 1201 to reach the position me2 at time t3. As a result, the output shaft position detected by the output shaft encoder 1205 reaches the position oe2 at time t3, and the system control unit 1006 can reduce the error of the reference position produced by the backlash, regardless of the output shaft position when the reference position is determined.

FIG. 11 is a flowchart illustrating reference position determination processing of the pan/tilt head device 1000 according to the third embodiment. The processor 1191 of the system control unit 1006 executes the reference position determination processing of this flowchart by reading out a computer program from the storage 1193 and loading the program and various types of data into the memory 1192. The system control unit 1006 may execute the flowchart in FIG. 11 when determining the reference position, e.g., in initialization processing performed when the apparatus is turned on. For the sake of simplicity, reference position determination processing for the pan direction is described in the present embodiment, but it is assumed that the reference position determination processing for the tilt direction is performed through the same flow.

In step S4001, the system control unit 1006 drives the motor 1201 of the pan driving unit 1004 in the elimination direction by the elimination movement amount. The elimination direction may be a direction in which the backlash is removed or eliminated. For example, the system control unit 1006 may set the elimination direction in light of characteristics related to backlash in the reduction mechanism 1203 of the pan driving unit 1004, the effects of the weight of the camera head 1104 itself and of other members, the movement direction before this processing is executed, and the like. The elimination movement amount may be set based on the backlash, to a movement amount sufficient for eliminating the backlash. Specifically, the elimination movement amount may be set in advance to a value obtained by adding a margin that takes variation into account, based on design values, actual measurement results, and the like. If the same amount of backlash is eliminated regardless of the direction, the system control unit 1006 may drive the motor 1201 in either direction. Here, the system control unit 1006 drives the motor 1201 in the positive direction, which is the elimination direction, by one degree, which is the elimination movement amount.

In step S4002, the system control unit 1006 obtains the output shaft position from the output shaft encoder 1205 provided in the output shaft 1204 of the pan driving unit 1004, determines the obtained output shaft position as the reference position, and ends this processing. The system control unit 1006 then performs position control using the motor control position of the motor 1201 based on the determined reference position.

The system control unit 1006 performs the same processing as the pan control described above for the tilt control of the pan/tilt head device 1000 as well.

In this manner, in a configuration in which the pan/tilt head device 1000 of the third embodiment determines the reference position for the position control using the output shaft encoder 1205 of the output shaft 1204 of the pan driving unit 1004 and the tilt driving unit 1005, the reference position is determined after the motors 1201 of the pan driving unit 1004 and the tilt driving unit 1005 are driven in the elimination direction by an elimination movement amount sufficient for eliminating the backlash. This makes it possible to reduce error in the reference position produced by the backlash. The pan/tilt head device 1000 also eliminates the backlash by driving the motors 1201 in the elimination direction by the elimination movement amount, which makes it possible to shorten the time taken by the initialization processing, in which processing for determining the reference position is performed, and reduce the processing load.

The pan/tilt head device 1000 according to the third embodiment includes a brushless DC motor as the motor 1201 serving as the drive source of the pan driving unit 1004 and the tilt driving unit 1005, and a motor shaft encoder 1202 that detects the motor control position of the motor 1201 on the motor shaft. Although an example in which the pan/tilt head device 1000 controls the position of the motor 1201 using the motor control position detected by the motor shaft encoder 1202 has been described here, the control method is not limited thereto. For example, the pan/tilt head device 1000 may be configured to use a stepping motor as the motor 1201 serving as the drive source, with the system control unit 1006 controlling the motor control position based on a step number, a pulse number, or the like of the stepping motor, and the reference position may be determined through the same method as that described in the first embodiment.

### Fourth Embodiment

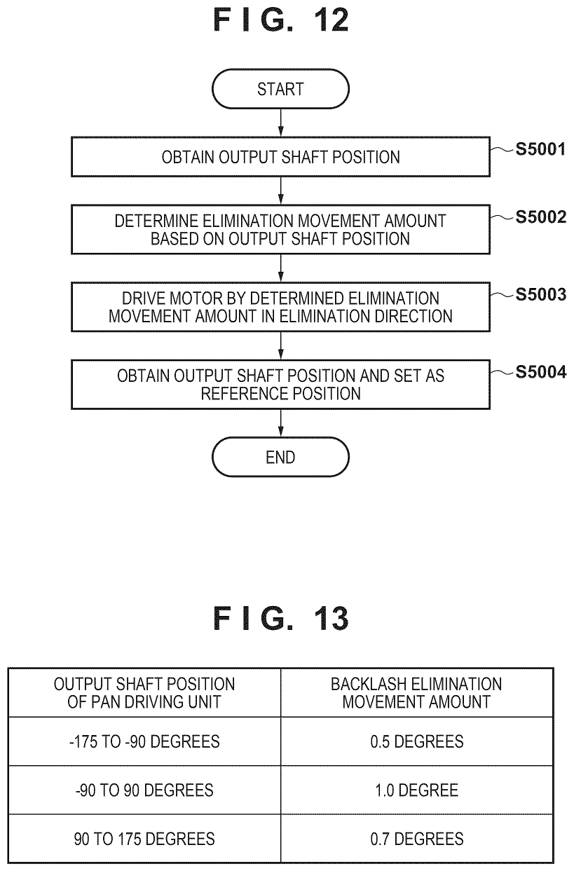

A method for appropriately performing control for eliminating backlash in accordance with conditions of a fourth embodiment will be described next with reference to FIGS. 12, 13, 16A, and 16B. Elements that are the same as those in the third embodiment will be given the same reference signs as those already used, and detailed descriptions thereof will be omitted, with the descriptions instead focusing on the differences from the first embodiment. Such descriptions may be omitted in the same manner in the other embodiments described later.

Although the third embodiment described a method for determining a reference position for with the movement amount for eliminating backlash being obtained uniformly, the method for determining the reference position is not limited thereto. For example, the system control unit 1006 may change the movement amount for eliminating the backlash when determining the reference position in accordance with the position of the motor 1201 of the pan driving unit 1004. In addition, when the position of the motor 1201 of the tilt driving unit 1005 is oriented to 0 degrees, i.e., in the horizontal direction, the backlash may tighten under the weight of the camera head 1104 itself. In this case, movement for eliminating the backlash is unnecessary. In this manner, the state of the backlash may differ depending on the position of the motor 1201. Accordingly, the system control unit 1006 may set the elimination movement amount for eliminating the backlash in accordance with the output shaft position of the motors 1201 of the tilt driving unit 1005 and the pan driving unit 1004 when determining the reference position.

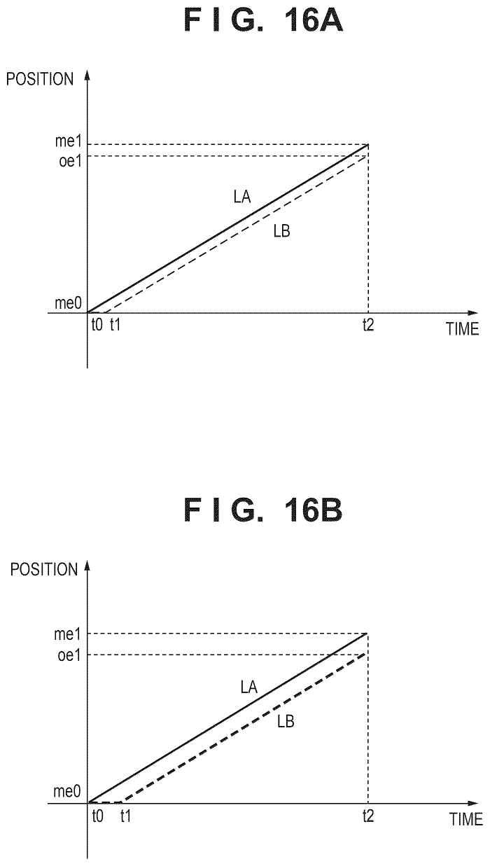

Error caused by different backlashes will be described next with reference to FIGS. 16A and 16B.

FIGS. 16A and 16B are diagrams illustrating the relationship between the motor control position and the output shaft position of a driving unit in an example pan/tilt head device. FIG. 16A illustrates a state in which the backlash is relatively tight, and FIG. 16B illustrates a state in which the backlash is relatively loose. In FIGS. 16A and 16B, the horizontal axis is the time axis. The vertical axis represents the motor control position, i.e., the value of the motor shaft encoder 1202, and the output shaft position, i.e., the value of the output shaft encoder 1205. The solid line indicates the movement trajectory LA of the motor shaft encoder 1202. The dotted line indicates the movement trajectory LB of the output shaft encoder 1205.

In FIG. 16A, at time t0, the system control unit 1006 reads out the output shaft position detected by the output shaft encoder 1205 and determines the reference position. The system control unit 1006 sets the value of the motor shaft encoder 1202 to the position me0, based on the determined reference position. From there, the system control unit 1006 drives the motor 1201 to the position me1 based on the motor control position. At this time, the motor control position detected by the motor shaft encoder 1202 changes linearly, as indicated by the movement trajectory LA. However, for the output shaft position detected by the output shaft encoder 1205, even if the motor 1201 rotates at the point in time when the driving begins, there is a period in which the output shaft 1204 does not rotate due to the backlash in the reduction mechanism 1203. Specifically, from time t0 t0 time t1, the output shaft position detected by the output shaft encoder 1205 does not change, as indicated by the movement trajectory LB. The output shaft position only begins to change from the point in time when time t1 is exceeded, and changes linearly thereafter. Then, at time t2, when the motor control position of the motor 1201 reaches the position me1, the output shaft position detected by the output shaft encoder 1205 becomes the position oe1 from the position me1, which is slightly insufficient.

Similarly, in FIG. 16B, at time t0, the system control unit 1006 reads out the output shaft position detected by the output shaft encoder 1205, determines the reference position, and sets the value of the motor shaft encoder 1202 to the position me0, based on the determined reference position. From there, the system control unit 1006 moves the motor 1201 to the position me1. At that time, the motor control position of the motor shaft encoder 1202 and the output shaft position of the output shaft encoder 1205 follow a movement trajectory similar to that illustrated in FIG. 16A. Specifically, the section where, due to backlash in the reduction mechanism at the point in time where the driving begins, the output shaft does not rotate even if the motor rotates for a certain period of time, i.e., the section where the value of the output shaft encoder 1205 does not change from time t0 to t1, is slightly longer in FIG. 16B, because the backlash is relatively loose compared to FIG. 16A. In addition, at time t2, when the motor 1201 reaches the position me1, the position oe1 detected by the output shaft encoder 1205 corresponds to a more insufficient amount in FIG. 16B than in FIG. 16A. Between the states illustrated in FIG. 16A and the state illustrated in FIG. 16B, different error occurs in the stop position at time t2, which is when the motor 1201 reaches the position me1.

In this manner, when the system control unit 1006 determines the reference position, based on the output shaft position detected by the output shaft encoder 1205, error is produced in the reference position according to the state of the amount of positional variation caused by the backlash. Additionally, when the system control unit 1006 controls the position of the motors 1201 based on that reference position in a situation where the backlash varies, different error in the stop position will be produced as well.

FIG. 12 is a flowchart illustrating reference position determination processing of the pan/tilt head device 1000 according to the fourth embodiment. The processor 1191 of the system control unit 1006 executes the reference position determination processing of this flowchart by reading out a computer program from the storage 1193 and loading the program and various types of data into the memory 1192. The system control unit 1006 may execute the flowchart in FIG. 12 when determining the reference position, e.g., in initialization processing performed when the apparatus is turned on. For the sake of simplicity, reference position determination processing for the pan direction is described in the present embodiment, but it is assumed that the reference position determination processing for the tilt direction is performed through the same flow.

In step S5001, the system control unit 1006 obtains the output shaft position of the pan driving unit 1004 from the output shaft encoder 1205.

In step S5002, based on a movement amount table, the system control unit 1006 determines the elimination movement amount for eliminating the backlash based on the obtained output shaft position of the pan driving unit 1004.

FIG. 13 is a diagram illustrating an example of the movement amount table. The movement amount table associates a plurality of ranges of the output shaft position of the pan driving unit 1004 with elimination movement amounts for eliminating the backlash. The elimination movement amounts in the movement amount table are, for example, movement amounts sufficient to eliminate the backlash in accordance with each range of the output shaft position of the pan driving unit 1004. The elimination movement amount is added to a margin that takes into account variation in the backlash, based on design values, actual measurement results for the backlash, and the like. In the movement amount table in FIG. 13, when the output shaft position of the pan driving unit 1004 is −175 degrees to −90 degrees, the elimination movement amount is set to 0.5 degrees. When the output shaft position of the pan driving unit 1004 is −90 degrees to 90 degrees, the elimination movement amount is set to 1.0 degrees. When the output shaft position of the pan driving unit 1004 is 90 degrees to 175 degrees, the elimination movement amount is set to 0.7 degrees. In the movement amount table described here, the output shaft position of the pan driving unit 1004 is divided into three ranges and a movement amount is associated with each range, but the number of divisions may be changed as appropriate.

If the relationship between the output shaft position of the pan driving unit 1004 and the movement amount for eliminating the backlash can be expressed by a predetermined formula, the system control unit 1006 may calculate the movement amount for eliminating the backlash by using the formula instead of the movement amount table. Here, the system control unit 1006 sets the output shaft position of the pan driving unit 1004 obtained from the output shaft encoder 1205 to −100 degrees, and based on the movement amount table, the system control unit 1006 sets the movement amount for eliminating the backlash to 0.5 degrees.

In step S5003, the system control unit 1006 causes the motor 1201 of the pan driving unit 1004 to drive in the elimination direction by the elimination movement amount determined based on the movement amount table. The system control unit 1006 may set the direction in which the backlash is to be eliminated or reduced as the elimination direction. Here, the system control unit 1006 drives the motor 1201 in the positive direction by the 0.5 degrees set in step S5002.

In step S5004, the system control unit 1006 obtains the output shaft position from the output shaft encoder 1205 of the pan driving unit 1004, determines the obtained output shaft position as the reference position, and ends this processing. The system control unit 1006 then performs position control using the motor control position of the motor 1201 based on the determined reference position.

The pan/tilt head device 1000 performs the same reference position determination processing as the pan control described above for the tilt control as well.

The pan/tilt head device 1000 according to the fourth embodiment determines the reference position having eliminated the backlash based on the elimination movement amount determined in accordance with the position in the pan direction. As a result, the fourth embodiment can accurately determine the reference position having appropriately eliminated the backlash, even if the backlash amount differs from position to position in the pan direction due to tolerances, assembly error, and the like of each component.

### Fifth Embodiment

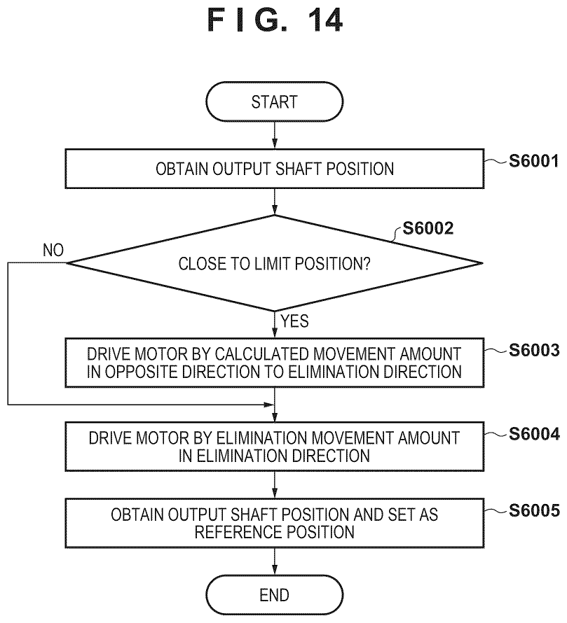

A method for appropriately performing control for eliminating backlash in accordance with conditions of a fifth embodiment will be described next with reference to FIG. 14. Elements that are the same as those in the foregoing embodiments will be given the same reference signs as those already used, and detailed descriptions thereof will be omitted, with the descriptions instead focusing on the differences from the foregoing embodiments. Such descriptions may be omitted in the same manner in the other embodiments described later.

Although the fourth embodiment described a method for performing control for eliminating backlash through a uniform sequence, the method is not limited thereto. For example, the output shaft position of the pan driving unit 1004 may be near a limit position, which is the limit to which the output shaft can be driven in the movement direction for eliminating the backlash. In such a situation, the driving of the motor 1201 of the pan driving unit 1004 is limited to the limit position, and thus the pan driving unit 1004 cannot be driven enough to eliminate the backlash. In this case, based on the output shaft position, the system control unit 1006 first determines whether to drive the pan driving unit 1004 in the direction opposite from the direction of eliminating the backlash, i.e., in the direction opposite from the limit position. Then, if, for example, the output shaft position is within a predetermined range from the limit position, the system control unit 1006 may determine the reference position by driving the motor 1201 in the direction opposite from the elimination direction, and then driving the motor 1201 in the elimination direction which eliminates the backlash.

FIG. 14 is a flowchart illustrating reference position determination processing of the pan/tilt head device 1000 according to the fifth embodiment. The processor 1191 of the system control unit 1006 executes the reference position determination processing of this flowchart by reading out a computer program from the storage 1193 and loading the program and various types of data into the memory 1192. The system control unit 1006 may execute the flowchart in FIG. 14 when determining the reference position, e.g., in initialization processing performed when the apparatus is turned on. For the sake of simplicity, reference position determination processing for the pan direction is described in the present embodiment, but it is assumed that the reference position determination processing for the tilt direction is performed through the same flow.

In step S6001, the system control unit 1006 obtains the output shaft position of the pan driving unit 1004 from the output shaft encoder 1205.

In step S6002, the system control unit 1006 determines whether the obtained output shaft position of the pan driving unit 1004 is close to the limit position on the side corresponding to the elimination direction for eliminating the backlash. As described above, the limit position in the pan direction is 175 degrees in both the positive direction and the negative direction. Here, assuming that the elimination direction for eliminating the backlash is set to the positive direction, the system control unit 1006 determines whether the output shaft position is close to the limit position in the positive direction. Specifically, the system control unit 1006 may determine whether the output shaft position is close to the limit position according to whether the output shaft position is within a predetermined position range, which here is +174 degrees or higher. If the output shaft position is determined to be close to the limit position, the system control unit 1006 moves the sequence to step S6003. If the system control unit 1006 determines that the output shaft position is not close to the limit position, the sequence moves to step S6004. For example, if the output shaft position is at +174.8 degrees, the system control unit 1006 determines that the output shaft position is close to the limit position, and moves the sequence to step S6003.

In step S6003, the system control unit 1006 calculates the movement amount and causes the motor 1201 of the pan driving unit 1004 to drive in the direction opposite from the elimination direction in which the backlash is eliminated (here, the positive direction) by the calculated movement amount. Specifically, the system control unit 1006 drives the motor 1201 of the pan driving unit 1004 in the direction opposite from the limit position in the positive direction, i.e., in the negative direction, by the calculated movement amount. The system control unit 1006 calculates the movement amount in the opposite direction by adding a predetermined movement amount to the elimination movement amount sufficient for eliminating the backlash. In other words, the movement amount is greater than the elimination movement amount. For example, as expressed by the following formula, the system control unit 1006 adds 1.0 degrees to 0.5 degrees, which is the elimination movement amount sufficient for eliminating the backlash indicated in FIG. 13, which results in a calculation of 1.5 degrees as the movement amount in the opposite direction.

$$0.5 + 1.0 = 1.5 degrees$$

The system control unit 1006 drives the motor 1201 of the pan driving unit 1004 in the negative direction by 1.5 degrees, which is the movement amount calculated.

In step S6004, the system control unit 1006 drives the motor 1201 of the pan driving unit 1004 in the elimination direction by the elimination movement amount. Here, the elimination direction may be the direction toward the limit position. The elimination movement amount may be a movement amount sufficient to eliminate the backlash indicated in the movement amount table in FIG. 13, e.g., 0.5 degrees.

In step S6005, the system control unit 1006 obtains the output shaft position of the pan driving unit 1004 from the output shaft encoder 1205, determines the obtained output shaft position as the reference position, and ends this processing. The system control unit 1006 then performs position control of the motor control position of the motor 1201 based on the reference position determined here.

The same processing as the pan control described above is performed for the tilt control of the pan/tilt head device 1000 as well.

In the pan/tilt head device 1000 according to the fifth embodiment, the output shaft is at a limit position at which a movement amount sufficient for eliminating the backlash cannot be secured, the motor 1201 of the pan driving unit 1004 is driven in the direction opposite from the elimination direction, and is then driven in the elimination direction. This makes it possible for the pan/tilt head device 1000 to accurately determine the reference position by sufficiently eliminating the backlash even at the limit position.

The pan/tilt head device 1000 according to the fifth embodiment sets the movement amount for driving in the direction opposite from the elimination direction to be greater than the elimination movement amount at which the backlash can be sufficiently eliminated. Through this, when driving the motor 1201 in the elimination direction, the pan/tilt head device 1000 can drive the motor 1201 by an elimination movement amount that sufficiently eliminates the backlash.

### Sixth Embodiment

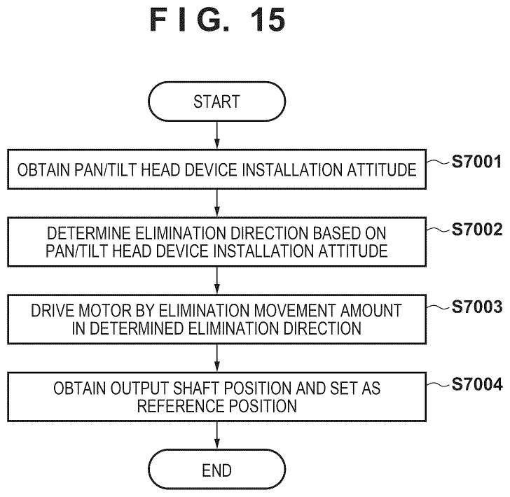

A method for appropriately performing control for eliminating the backlash amount in accordance with conditions of a sixth embodiment will be described next with reference to FIG. 15. Elements that are the same as those in the foregoing embodiments will be given the same reference signs as those already used, and detailed descriptions thereof will be omitted, with the descriptions instead focusing on the differences from the foregoing embodiments. Such descriptions may be omitted in the same manner in the other embodiments.

Although the fifth embodiment described a method for determining the reference position with the elimination direction of the motor 1201 for eliminating backlash being a uniform direction, the method for determining the reference position is not limited thereto. For example, the attitude at which the pan/tilt head device 1000 is installed includes an upright state and an inverted state. The inverted state is, for example, a state in which the pan/tilt head device 1000 is installed in an inverted position, from a ceiling, a pole, or the like. Since the direction of the force produced by the weight of the camera head 1104 itself differs depending on the installation attitude, the elimination direction for eliminating the backlash changes in accordance with the installation attitude. In such a case, the system control unit 1006 may set the elimination direction for eliminating the backlash based on the installation attitude of the pan/tilt head device 1000.

FIG. 15 is a flowchart illustrating reference position determination processing of the pan/tilt head device 1000 according to the sixth embodiment. The processor 1191 of the system control unit 1006 executes the reference position determination processing of this flowchart by reading out a computer program from the storage 1193 and loading the program and various types of data into the memory 1192. The system control unit 1006 may execute the flowchart in FIG. 15 when determining the reference position, e.g., in initialization processing performed when the apparatus is turned on. For the sake of simplicity, reference position determination processing for the tilt direction is described in the present embodiment, but it is assumed that the reference position determination processing for the pan direction is performed through the same flow.

In step S7001, the system control unit 1006 obtains installation attitude information of the pan/tilt head device 1000. The system control unit 1006 may receive an indication as to whether the installation attitude of the pan/tilt head device 1000 is the upright state or the inverted state from the operator through an input device. Alternatively, a sensor that detects the direction of gravity, such as an accelerometer, may be provided in the pan/tilt head device 1000, and the system control unit 1006 may determine the installation attitude based on an acceleration value obtained from the accelerometer. The installation attitude of the pan/tilt head device 1000 is assumed to be the inverted state here.

In step S7002, the system control unit 1006 determines the elimination direction for the motor 1201 of the tilt driving unit 1005 based on the installation attitude of the pan/tilt head device 1000. The elimination direction is the direction that eliminates the backlash of the tilt driving unit 1005, and is determined according to the installation attitude. For example, when the pan/tilt head device 1000 is in the upright state, the tilt driving unit 1005 exerts a force downward, i.e., in the negative direction, due to the weight of the camera head 1104 itself. In this case, the system control unit 1006 determines the elimination direction as the positive direction. On the other hand, when the pan/tilt head device 1000 is in the inverted state, the tilt driving unit 1005 exerts a force upward, i.e., in the positive direction. In this case, the system control unit 1006 determines the elimination direction as the negative direction. Here, the installation attitude is the inverted state, and the system control unit 1006 therefore determines the elimination direction as the negative direction.

In step S7003, the system control unit 1006 drives the motor 1201 of the tilt driving unit 1005 in the elimination direction determined in step S7002 by the elimination movement amount. The system control unit 1006 may determine the elimination movement amount in the same manner as in the foregoing embodiments. Here, the system control unit 1006 drives the motor 1201 by an elimination movement amount of 0.5 degrees in the negative direction, which is the elimination direction.

In step S7004, the system control unit 1006 obtains the output shaft position of the tilt driving unit 1005 from the output shaft encoder 1205. The system control unit 1006 takes the obtained output shaft position as the reference position, and ends this processing. The system control unit 1006 then performs position control of the motor control position of the motor 1201 based on the reference position determined.

The same processing as the tilt control described above is performed for the pan control of the pan/tilt head device 1000 as well.

The pan/tilt head device 1000 according to the sixth embodiment determines the elimination direction in accordance with the installation attitude of the pan/tilt head device 1000, drives the motor 1201 in that elimination direction, eliminates the backlash, and determines the reference position. This makes it possible for the pan/tilt head device 1000 to determine the reference position having appropriately eliminated the backlash, regardless of the installation attitude.

As described above, the pan/tilt head device 1000 according to each embodiment determines the reference position for the position control using the output shaft encoders 1205 of the pan driving unit 1004 and the tilt driving unit 1005. In such a configuration, the pan/tilt head device 1000 determines the reference position after performing control for eliminating the backlash through a more appropriate elimination movement amount, elimination direction, and control sequence, determined based on the positions of the pan driving unit 1004 and the tilt driving unit 1005 and the installation attitude of the pan/tilt head device 1000. Through this, the pan/tilt head device 1000 can reduce error in the reference position produced by the backlash, and can furthermore shorten the initialization processing time in which the processing for determining the reference position is performed, as well as reduce the processing load.

The foregoing embodiments may be combined. When embodiments are combined, the method for determining the reference position may be accepted from the operator.

The foregoing embodiments may be combined. For example, the backlash calculation processing of each embodiment may be configured to be executable in a single pan/tilt head device and selectable by an operator.

Although the foregoing embodiments described examples in which the image capturing apparatus 2000 and the pan/tilt head device 1000 are separate, the configuration of the pan/tilt head device 1000 is not limited thereto. For example, the pan/tilt head device and the image capturing apparatus may be configured as a single integrated entity.

According to the present disclosure, the burden on an operator can be reduced when calculating a backlash amount. Additionally, according to the present disclosure, error in the reference position produced by backlash in the pan/tilt head device can be reduced.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-122554, filed Jul. 29, 2024, and Japanese Patent Application No. 2024-122555, filed Jul. 29, 2024 which are hereby incorporated by reference herein in their entirety.

What is claimed is:

1. A pan/tilt head device that changes a shooting direction of an image capturing unit that captures an image of a subject, the pan/tilt head device comprising:
a drive source that outputs a drive force;
a reduction mechanism that reduces the drive force of the drive source;
an output shaft, connected to the reduction mechanism, to which the drive force reduced is transmitted, the output shaft changing the shooting direction of the image capturing unit using the drive force;
a first detection unit that detects an output shaft position that is a position of the output shaft; and
a control unit that controls the drive source,
wherein, based on a condition set in advance, the control unit obtains at least one of the output shaft position and a control position that is a position of the drive source, and obtains a backlash amount, based on the control position and the output shaft position obtained.

2. The pan/tilt head device according to claim 1,
wherein the first detection unit is an absolute value encoder.

3. The pan/tilt head device according to claim 1, further comprising:
a second detection unit that detects the control position of the drive source.

4. The pan/tilt head device according to claim 1,
wherein the drive source is a stepping motor, and
the control unit uses a number of pulses of the stepping motor as the control position of the drive source.

5. The pan/tilt head device according to claim 1,
wherein the control unit calculates the backlash amount, based on a first output shaft position that is the output shaft position at a point in time when the drive source is driven to a predetermined position in a first direction.

6. The pan/tilt head device according to claim 5,
wherein the control unit calculates the backlash amount, based on a difference between the first output shaft position and a second output shaft position that is the output shaft position at a point in time when the drive source is driven to the predetermined position in a second direction opposite from the first direction.

7. The pan/tilt head device according to claim 5,
wherein before causing the drive source to drive in the first direction, the control unit causes the drive source to drive in a second direction that is opposite from the first direction by a movement amount capable of eliminating the backlash amount.

8. The pan/tilt head device according to claim 1,
wherein the control unit:
obtains a first control position of the drive source, the first control position being the control position at a drive starting time that is a point in time when the drive source being driven in a first direction starts being driven in a second direction opposite from the first direction;
obtains a second control position of the drive source at a point in time when the output shaft position changes after the drive starting time; and
calculates a difference between the first control position and the second control position as the backlash amount.

9. The pan/tilt head device according to claim 1,
wherein the control unit:
obtains a first control position of the drive source, the first control position being the control position at a point in time when the output shaft position has stopped changing after the drive source being driven in a first direction starts being driven in a second direction opposite from the first direction;
obtains a second control position of the drive source at a point in time when the output shaft position resumes changing; and
calculates a difference between the first control position and the second control position as the backlash amount.

10. A control method for a pan/tilt head device that changes a shooting direction of an image capturing unit that captures an image of a subject, the pan/tilt head device including:
a drive source that outputs a drive force;
a reduction mechanism that reduces the drive force of the drive source;
an output shaft, connected to the reduction mechanism, to which the drive force reduced is transmitted, the output shaft changing the shooting direction of the image capturing unit using the drive force;
a first detection unit that detects an output shaft position that is a position of the output shaft; and
a control unit that controls the drive source,
the method comprising:
based on a condition set in advance, obtaining at least one of the output shaft position and a control position that is a position of the drive source, and obtaining a backlash amount, based on the control position and the output shaft position obtained.

11. A pan/tilt head device that changes a shooting direction of an image capturing unit that captures an image of a subject, the pan/tilt head device comprising:
a drive source that outputs a drive force;
a reduction mechanism that reduces the drive force of the drive source;
an output shaft, connected to the reduction mechanism, to which the drive force reduced is transmitted, the output shaft changing the shooting direction of the image capturing unit using the drive force;
a first detection unit that detects an output shaft position that is a position of the output shaft; and
a control unit that controls the drive source,
wherein the control unit determines, as a reference position for controlling a position of the drive source, the output shaft position obtained after driving the drive source by an elimination movement amount in an elimination direction, the elimination direction being a direction that eliminates backlash produced by the reduction mechanism.

12. The pan/tilt head device according to claim 11,
wherein the first detection unit is an absolute value encoder.

13. The pan/tilt head device according to claim 11, further comprising:
a second detection unit that detects the control position of the drive source.

14. The pan/tilt head device according to claim 11,
wherein the drive source is a stepping motor, and
the control unit uses a number of pulses of the stepping motor as the control position of the drive source.

15. The pan/tilt head device according to claim 11,
wherein the control unit determines the elimination movement amount, based on backlash in the reduction mechanism.

16. The pan/tilt head device according to claim 11,
wherein the control unit determines the elimination movement amount, based on the output shaft position, and determines the output shaft position obtained after driving the drive source by the elimination movement amount as the reference position.

17. The pan/tilt head device according to claim 16,
wherein the control unit determines the elimination movement amount, based on a movement amount associated with a plurality of ranges of the output shaft position.

18. The pan/tilt head device according to claim 11,
wherein the control unit determines whether to drive the drive source in an opposite direction that is opposite from the elimination direction, based on the output shaft position, and determines the reference position.

19. The pan/tilt head device according to claim 18,
wherein in a case where the output shaft position is within a predetermined position range, the control unit determines, as the reference position, the output shaft position obtained when the drive source is driven in the opposite direction and is then driven in the elimination direction.

20. The pan/tilt head device according to claim 19,
wherein the predetermined position range is a predetermined range from a position of a limit of a range over which the drive source is capable of driving.

21. The pan/tilt head device according to claim 18,
wherein when driving the drive source in the opposite direction, the control unit causes the drive source to drive in the opposite direction by a movement amount greater than the elimination movement amount in the elimination direction.

22. The pan/tilt head device according to claim 11,
wherein the control unit determines the elimination direction, based on an attitude of the pan/tilt head device, and determines the reference position.

23. A control method for a pan/tilt head device that changes a shooting direction of an image capturing unit that captures an image of a subject, the pan/tilt head device including:
a drive source that outputs a drive force;
a reduction mechanism that reduces the drive force of the drive source;
an output shaft, connected to the reduction mechanism, to which the drive force reduced is transmitted, the output shaft changing the shooting direction of the image capturing unit using the drive force;
a first detection unit that detects an output shaft position that is a position of the output shaft; and
a control unit that controls the drive source,
the method comprising:
determining, as a reference position for controlling a position of the drive source, the output shaft position obtained after driving the drive source by an elimination movement amount in an elimination direction, the elimination direction being a direction that eliminates backlash produced by the reduction mechanism.

24. A non-transitory computer-readable storage medium storing a computer program that, when read and executed by a computer of a pan/tilt head device that changes a shooting direction of an image capturing unit that captures an image of a subject, the pan/tilt head device including:
a drive source that outputs a drive force;
a reduction mechanism that reduces the drive force of the drive source;
an output shaft, connected to the reduction mechanism, to which the drive force reduced is transmitted, the output shaft changing the shooting direction of the image capturing unit using the drive force; and
a first detection unit that detects an output shaft position that is a position of the output shaft,
causes the computer to function as:
a control unit that controls the drive source,
wherein, based on a condition set in advance, the control unit obtains at least one of the output shaft position and a control position that is a position of the drive source, and obtains a backlash amount, based on the control position and the output shaft position obtained.

25. A non-transitory computer-readable storage medium storing a computer program that, when read and executed by a computer of a pan/tilt head device that changes a shooting direction of an image capturing unit that captures an image of a subject, the pan/tilt head device comprising:
a drive source that outputs a drive force;
a reduction mechanism that reduces the drive force of the drive source;
an output shaft, connected to the reduction mechanism, to which the drive force reduced is transmitted, the output shaft changing the shooting direction of the image capturing unit using the drive force; and
a first detection unit that detects an output shaft position that is a position of the output shaft,
causes the computer to function as:
a control unit that controls the drive source,
wherein the control unit determines, as a reference position for controlling a position of the drive source, the output shaft position obtained after driving the drive source by an elimination movement amount in an elimination direction, the elimination direction being a direction that eliminates backlash produced by the reduction mechanism.
